(19) United States
(12) Patent Application Publication
(10) Pub. No.: US 2026/0338632 A1
(43) Pub. Date: Oct. 29, 2026

(54) DATA-MODEL DUAL-DRIVEN FAULT DIAGNOSIS METHOD AND SYSTEM FOR OIL AND GAS PIPELINE NETWORK IN CLASS IMBALANCE DATA SCENARIO

(71) Applicant: NORTHEAST PETROLEUM UNIVERSITY, Daqing (CN)

(72) Inventors: Chuang WANG, Daqing (CN); Hongli DONG, Daqing (CN); Rou SHANG, Daqing (CN); Zhihua WANG, Daqing (CN); Wenhe LI, Daqing (CN); Qingqiang LIU, Daqing (CN); Peng WANG, Daqing (CN); Chao LI, Daqing (CN)

(73) Assignee: NORTHEAST PETROLEUM UNIVERSITY, Daqing (CN)

(21) Appl. No.: 19/703,437

(22) Filed: Jun. 10, 2026

Related U.S. Application Data
(63) Continuation of application No. PCT/CN2024/140475, filed on Dec. 19, 2024.

(30) Foreign Application Priority Data
Aug. 6, 2024 (CN) 202410449534.6

(51) Int. Cl. G01M 3/28; G06N 3/094

(52) U.S. Cl. CPC G01M 3/2807; G06N 3/094

(57) ABSTRACT

A data-model dual-driven fault diagnosis method for an oil and gas pipeline network in a class imbalance data scenario includes: a thorough understanding of a propagation and attenuation mechanism of a negative pressure wave when oil and gas move in the pipeline network is provided, and a negative pressure wave attenuation physical model reflecting an operating state of the pipeline network is established; a deep generative adversarial model suitable for processing time sequence data is constructed based on a long short-term memory network; a reasonable series-parallel mechanism is designed to fuse the physical model and a data-driven model to construct a hybrid generative adversarial model; the trained hybrid generative adversarial model is used to generate pipeline network fault data and balance an original training set; and an intelligent fault diagnosis model is trained to realize pipeline fault type identification.

### CROSS-REFERENCE TO RELATED APPLICATIONS

This application is a continuation of International Application No. PCT/CN2024/140475, filed on Dec. 19, 2024, which claims priority to Chinese Patent Application No. 202410449534.6, filed on Aug. 6, 2024. All of the aforementioned applications are incorporated herein by reference in their entireties.

### TECHNICAL FIELD

The present disclosure relates to the technology of fault diagnosis for the oil and gas pipeline network, and belongs to the technical field of mechanical fault detection and diagnosis, in particular to a data-model dual-driven fault diagnosis method and system for an oil and gas pipeline network in a class imbalance data scenario.

### BACKGROUND

In recent years, with the continuous growth of energy demand and the extension of pipeline network operation life, the problems about potential safety hazards and rising maintenance costs caused by pipeline corrosion and aging have become increasingly prominent, which have brought great harm to life safety of people and social and economic development. Therefore, the development of an efficient, high-reliability, and low-cost fault diagnosis method for an oil and gas pipeline network has important practical requirements and great engineering significance for improving transportation reliability and safety, and reducing economic losses and operation and maintenance costs.

Deep learning, as an advanced artificial intelligence technology widely used in the field of industrial fault diagnosis, relies on the construction and training of multilayer neural networks to mimic information processing and learning mechanisms of the human brain. The deep learning technology can automatically extract key features from a large amount of industrial data and effectively identify complex fault modes and trends. However, a large deep learning model usually contains millions of parameters, and in order to avoid overfitting and ensure that the model can effectively learn from training data and adapt to new data, a large amount of input data is often required to support the model to capture broader and deeper data laws, as well as achieve accurate adjustment and optimization of network parameters. In the field of intelligent diagnosis of the oil and gas pipeline network, because fault events are relatively rare in practical operation, in comparison, the amount of data in a normal state is much larger than that of fault data. This imbalance between classes, namely, a class imbalance problem, causes the deep learning model to be possibly biased towards more frequently occurring classes, namely the normal state, during the training process, which in turn affects the performance of the model in accurately identifying a fault state.

In existing research on the class imbalance problem, generating the fault data and using the fault data to balance a data set is a widely concerned solution. However, a common problem is the excessive focus on the accuracy and similarity of generated data to real data on statistical indicators while neglecting the physical interpretability of the generated fault data. Generally speaking, a data-driven generative model with a complex structure struggles to clearly explain a decision-making basis and an operation logic, and the fault data that is similar to the real data in visual and statistical characteristics, but inconsistent in physical laws may be generated. This inconsistency can significantly increase the security risk of the generated fault data and seriously affect the accuracy of a fault diagnosis model, thereby increasing the risk of misdiagnosis and missed diagnosis.

For example, Chinese Patent Publication No. CN114964476B discloses a fault diagnosis method, apparatus, and device for an oil and gas pipeline system dynamic device. Vibration signals of the oil and gas pipeline system dynamic device to be detected are collected; continuous wavelet transform is performed on the vibration signals to obtain a two-dimensional time-frequency image; the two-dimensional time-frequency image is inputted into a pre-constructed convolutional neural network fault diagnosis model, and the convolutional neural network fault diagnosis model is used to perform fault diagnosis on the oil and gas pipeline system dynamic device to be detected to obtain a fault diagnosis result; and the fault diagnosis result is analyzed by using a LIME algorithm to obtain fault analysis information, where the fault analysis information involves marking different energy intensities on the two-dimensional time-frequency image, and the different energy intensities represent different contributions of time-frequency regions corresponding to the energy intensities to the fault diagnosis result. However, a problem about class imbalance datasets, which often appears in fault diagnosis research, is not raised.

In the existing fault diagnosis technology of an oil and gas pipeline (or a pipeline network), no one pays attention to the problem of class imbalance data sets which often appears in the fault diagnosis research and gives targeted solutions, which affects the accuracy and practicability of fault diagnosis of the oil and gas pipeline (or the pipeline network). In addition, a conventional generative adversarial model constructed based on a deep neural network is directly used in the fault diagnosis of the oil and gas pipeline (or the pipeline network), which may reduce the physical interpretability and quality of the generated fault data, thus affecting the fault diagnosis accuracy of the oil and gas pipeline (or the pipeline network). Therefore, overfitting problems faced by a current intelligent fault diagnosis model when dealing with the class imbalance data sets in oilfields, as well as the risks of false alarm and missed alarm, still exist. How to continuously improve the accuracy of fault diagnosis for the oil and gas pipeline network remains an ongoing challenge.

### SUMMARY

For the defects in the prior art, the present disclosure provides a data-model dual-driven fault diagnosis method and system for an oil and gas pipeline network in a class imbalance data scenario, for solving overfitting problems faced by a current intelligent fault diagnosis model when dealing with class imbalance data sets in oilfields, as well as problems about risks of false alarm and missed alarm.

A technical solution adopted by the present disclosure to solve the above-mentioned technical problems is as follows.

A data-model dual-driven fault diagnosis method for an oil and gas pipeline network in a class imbalance data scenario includes the following steps:

Step 1: Collect key pipeline network parameters and construct a training data set

An oil and gas pipeline network monitoring system is used to acquire pipeline network negative pressure wave parameters and construct a training set

$${D}_{r} = {\{ {x}_{i}^{r} , {y}_{i}^{r} \}}_{i = 1}^{{n}^{r}} ,$$

where

$${x}_{i}^{r}$$

is i-th real pipeline data composed of N sampling points;

$${y}_{i}^{r}$$

is an i-th data label; and n^{r} is the number of data.

Step 2: Establish a negative pressure wave attenuation physical model

Change laws of pipeline network negative pressure wave characteristics under the influence of environmental and external factors are analyzed, and pipeline flow equations of the pipeline network are established based on the principles of mass conservation and momentum conservation, namely a set of hyperbolic partial differential equations composed of a continuity equation and a motion equation for fluid:

$$\frac{\partial ρ}{\partial t} + ∇ \cdot ( ρ v ) = 0 \qquad ( 1 )$$

$$\frac{\partial v}{\partial t} + v \frac{\partial v}{\partial x} + \frac{1}{ρ} \frac{\partial p}{\partial x} + g sin θ + \frac{λ}{2 D} v \vert v \vert = 0 \qquad ( 2 )$$

ρ is a fluid density, v is a flow velocity, t is time, p is a pressure, g is a gravitational acceleration, θ is a pipeline inclination angle, D is a pipeline inner diameter, λ is a friction coefficient, and x is an axial distance along a pipeline.

The hyperbolic partial differential equations composed of the formula (1) and the formula (2) are solved using a method of characteristics and a finite difference method. By combining pipeline leakage boundary conditions and a leakage rate, an expression for a negative pressure wave at a leakage point may be obtained as:

$$\vert Δ p \vert = {ρα}_{s} \frac{{mv}_{0}}{2 - m} \qquad ( 3 )$$

Δp is a pressure change at the leakage point, αₛ is a pressure wave velocity, m is the leakage rate, and v₀ is a flow velocity before the pipeline leaks.

Neglecting an energy loss caused by a fluid movement in the pipeline network, by analyzing attenuation characteristics of the negative pressure wave during propagation, it can be concluded through a plurality of experimental analyses that an attenuation law of the negative pressure wave during transmission approximates exponential decay, with an expression being:

$${p}_{i} = {ρα}_{s} \frac{{mv}_{0}}{2 - m} {e}^{- β x} \qquad ( 4 )$$

$${p}_{o} = {ρα}_{s} \frac{{mv}_{0}}{2 - m} {e}^{- β ( l - x )} \qquad ( 5 )$$

pᵢ an pₒ are negative pressure wave pressure values at an inlet and an outlet of the pipeline network, respectively, β is a negative pressure wave attenuation factor, and l is a pipeline length.

Step 3: Construct a deep generative adversarial model based on a long short-term memory (LSTM) network

The deep generative adversarial network (GAN) constructed based on the LSTM network includes one generator G and one discriminator D (both a pipeline inner diameter and the discriminator are denoted by the letter D, as the full name for the discriminator is “discriminator” and for the radius is “diameter”, and using other letters is inappropriate). An objective of the generator is to generate a data sequence similar to a real data sequence, and a formula may be expressed as:

$${h}_{t}^{g} = LSTM ( {z}_{t} , {h}_{t - 1}^{g} ) \qquad ( 6 )$$

$${x}^{f} = tan h ( {W}^{g} {h}_{t}^{g} + {b}^{g} ) \qquad ( 7 )$$

$${h}_{t}^{g}$$

is a hidden state of a generator LSTM unit at time t, zₜ is a noise input,

$${h}_{t - 1}^{g}$$

is a hidden state of the generator LSTM unit at time t−1, W^{g} and b^{g} are a weight and a bias of the generator respectively, and x^{f} is generated fault data.

Further, an objective of the discriminator is to correctly classify real data and generated data. When input data is the real data, a discriminator formula may be expressed as:

$${h}_{t}^{′} = LSTM ( {x}^{r} , {h}_{t - 1}^{′} ) \qquad ( 8 )$$

$${D}_{r} = sigmoid ( {W}^{d} {h}_{t}^{′} + {b}^{d} ) \qquad ( 9 )$$

h′ₜ is a hidden state of a discriminator LSTM unit at time t, x^{r} is real data, h′ₜ₋₁ is a hidden state of the discriminator LSTM unit at time t−1, and W^{d} and b^{d} are a weight and a bias of the discriminator respectively. When the input data is the generated data, the discriminator formula may be expressed as:

$${h}_{t}^{′} = LSTM ( {x}^{f} , {h}_{t - 1}^{′} ) \qquad ( 10 )$$

$${D}_{f} = sigmoid ( {W}^{d} {h}_{t}^{′} + {b}^{d} ) \qquad ( 11 )$$

An ultimate objective of a neural network is to achieve ideal classification performance by adjusting W^{d} and b^{d}, and therefore W^{d} and b^{d} are adaptively optimized according to a set loss function, rather than being manually specified.

Step 4: Construct a data-model dual-driven deep generative adversarial model using a series-parallel hybrid mechanism, namely, a hybrid generative adversarial model

The series-parallel hybrid mechanism firstly embeds an attenuation model into the generator, so as to ensure that the generated fault data conforms to the attenuation law of a negative pressure wave signal in a real operation scenario, and improve the physical rationality of the generated data. Accordingly, the negative pressure wave attenuation model needs to be embedded into the neural network (long short-term memory network) as a physical constraint layer (referring to the generator incorporating the physical constraint layer in FIG. 1), and the key parameter, namely the leakage rate m, is used as a parameter for network updates. Then, the mechanism uses a prediction error between an inlet-outlet pressure difference of the generated fault data and that of the real data as a regularization term to ensure that the generated fault data conforms to characteristics of a real pipeline network, with a formula shown below:

L_{phy}=∥\hat{p}ᵢ−pᵢ²∥+∥\hat{p}ₒ−pₒ∥² (12)

\hat{p}ₒ and \hat{p}ᵢ are the inlet-outlet pressure differences for the generated fault data, respectively.

Based on a formula (11), it can be obtained that a generator loss of the hybrid generative adversarial model is:

$${L}_{G} = - \frac{1}{{n}^{r}} {\sum }_{i = 1}^{{n}^{r}} log ( D ( {x}_{i}^{f} ) ) + {L}_{phy} \qquad ( 13 )$$

and
a discriminator loss of the hybrid generative adversarial model is:

$${L}_{D} = - \frac{1}{{n}^{r}} {\sum }_{i = 1}^{{n}^{r}} [ log ( D ( {x}_{i}^{r} ) ) + log ( 1 - D ( {x}_{i}^{f} ) ) ] \qquad ( 14 )$$

Step 5: Update network parameters using an RMSProp optimizer

The generator and the discriminator are alternately trained using the RMSProp optimizer, firstly, the generator is fixed, and the discriminator loss L_{D} is minimized; and then, the discriminator is fixed, and the generator loss L_{G} is minimized.

Step 6: Generate fault data using the hybrid generative adversarial model to balance the training set

After the training of the hybrid generative adversarial model is completed, noise in step 3 is inputted into the generator to generate the fault data for expanding the diagnostic training set.

Step 7: Train a diagnosis model to implement pipeline network fault type identification

The pipeline fault diagnosis model is trained by using the oil and gas pipeline network data set obtained in step 6 to obtain a pipeline fault class.

The present disclosure has following beneficial effects.

The present disclosure enables thorough understanding of a propagation and attenuation mechanism of the negative pressure wave when oil and gas move in the pipeline network, and the establishment of the negative pressure wave attenuation physical model reflecting an operating state of the pipeline network; the deep generative adversarial model suitable for processing time sequence data is constructed based on the long short-term memory (LSTM) network; a reasonable series-parallel mechanism is designed to fuse the physical model and a data-driven model to construct the hybrid generative adversarial model; the trained hybrid generative adversarial model is used to generate the pipeline network fault data and balance an original training set; and the intelligent fault diagnosis model is trained to realize pipeline fault type identification.

The present disclosure puts forward the problem about the class imbalance data sets which often appears in fault diagnosis and gives a targeted solution, thereby improving the accuracy and practicability of fault diagnosis of the oil and gas pipeline (or the pipeline network). The present disclosure also constructs the hybrid generative adversarial model based on the series-parallel hybrid mechanism, improves the physical interpretability and quality of the generated fault data, solves the overfitting problems faced by the current intelligent fault diagnosis model when dealing with the class imbalance data sets in oilfields, reduces the risk of false alarm and missed alarm, and finally realizes the improvement of intelligent fault diagnosis accuracy of the oil and gas pipeline network (the oil and gas pipeline).

The present disclosure simultaneously considers and integrates prior knowledge from the physical model and a learning ability of the data-driven model, and compared with the pure data-driven model, the prior knowledge about the pipeline network contained in the physical model can reduce a parameter space search domain, reduce an estimated parameter amount, improve the interpretability and generalization performance of the deep generative model, and also improve the physical rationality and characteristic distinguishability of the generated fault data, thereby effectively overcoming the negative influence of the class imbalance data sets on the performance of the diagnosis model, and further improving the intelligent fault diagnosis accuracy of the pipeline.

Compared with the prior art, the data-model dual-driven fault diagnosis method for an oil and gas pipeline network in a class imbalance data scenario according to the present disclosure at least has the following advantages and effects.

Different from a general intelligent fault diagnosis method based on a deep learning technology, the present disclosure mainly focuses on the problem of class imbalance data sets which often appears in the fault diagnosis research, and improves the accuracy and practicability of the intelligent fault diagnosis method by providing targeted solutions.

Different from a conventional generative adversarial model constructed based on a deep neural network, the present disclosure constructs the hybrid generative adversarial model based on the series-parallel hybrid mechanism. By integrating the physical model of pipeline network operational characteristics with the data-driven model, the parameter space search domain is effectively narrowed, the estimated parameter amount and the overfitting risk are reduced, meanwhile, the model is endowed with physical significance, and the physical interpretability and the quality of the generated fault data are improved.

Considering the current practical application of the intelligent fault diagnosis technology, this method has a practical application value and currently achieves certain application results.

### BRIEF DESCRIPTION OF THE DRAWINGS

FIG. 1 is a block diagram of a fault diagnosis process of a hybrid generative adversarial model according to an embodiment of the present disclosure.

FIG. 2 is a visualization example diagram of generated data and real data according to an embodiment of the present disclosure.

FIG. 3(a) is a comparative chart of data generated by the VAE model and real negative pressure wave data of oil and gas pipe networks according to an embodiment of the present disclosure.

FIG. 3(b) is a comparative chart of data generated by the GAN-minmax model and real negative pressure wave data of oil and gas pipe networks according to an embodiment of the present disclosure.

FIG. 3(c) is a comparative chart of data generated by the LSGAN model and real negative pressure wave data of oil and gas pipe networks according to an embodiment of the present disclosure.

FIG. 3(d) is a comparative chart of data generated by the InfoGAN model and real negative pressure wave data of oil and gas pipe networks according to an embodiment of the present disclosure.

FIG. 3(e) is a comparative chart of data generated by the SeqGAN model and real negative pressure wave data of oil and gas pipe networks according to an embodiment of the present disclosure.

FIG. 3(f) is a comparative chart of data generated by the TTS-GAN model and real negative pressure wave data of oil and gas pipe networks according to an embodiment of the present disclosure.

FIG. 3(g) is a comparative chart of data generated by the MAD-GAN model and real negative pressure wave data of oil and gas pipe networks according to an embodiment of the present disclosure.

FIG. 3(h) is a comparative chart of data generated by the hybrid generative adversarial model of the present disclosure and real negative pressure wave data of oil and gas pipe networks according to an embodiment of the present disclosure.

### DETAILED DESCRIPTION OF THE EMBODIMENTS

The present disclosure is further described below in conjunction with the accompanying drawings 1 to 3.

To enable those skilled in the art to better understand technical solutions in this application, the technical solutions in embodiments of this application will be described clearly and completely below in conjunction with the accompanying drawings in the embodiments of this application.

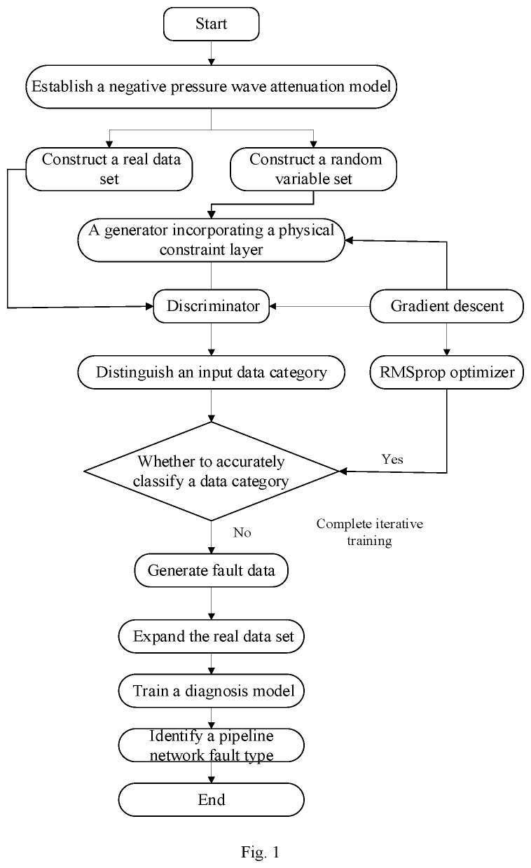

FIG. 1 is a block diagram of a data-model dual-driven fault diagnosis process for an oil and gas pipeline network in a class imbalance data scenario in the technical solution of the present disclosure, with an overall process implemented through Python programming. Referring to FIG. 1, a data-model dual-driven fault diagnosis method for an oil and gas pipeline network in a class imbalance data scenario includes the following steps:

Step 1: Collect key pipeline network parameters and construct a training data set

An oil and gas pipeline network monitoring system is used to acquire pipeline network negative pressure wave parameters and construct a training set

$${D}_{r} = {\{ {x}_{i}^{r} , {y}_{i}^{r} \}}_{i = 1}^{{n}^{r}} ,$$

where

$${x}_{i}^{r}$$

is i-th real pipeline data composed of N sampling points;

$${y}_{i}^{r}$$

is an i-th data label; and n^{r} is the number of data.

Step 2: Establish a negative pressure wave attenuation physical model

Change laws of pipeline network negative pressure wave characteristics under the influence of environmental and external factors are analyzed, and pipeline flow equations of the pipeline network are established based on the principles of mass conservation and momentum conservation, namely a set of hyperbolic partial differential equations composed of a continuity equation and a motion equation for fluid:

$$\frac{\partial ρ}{\partial t} + ∇ \cdot ( ρ v ) = 0 \qquad ( 1 )$$

$$\frac{\partial v}{\partial t} + v \frac{\partial v}{\partial x} + \frac{1}{ρ} \frac{\partial p}{\partial x} + g sin θ + \frac{λ}{2 D} v \vert v \vert = 0 \qquad ( 2 )$$

ρ is a fluid density, v is a flow velocity, t is time, p is a pressure, g is a gravitational acceleration, θ is a pipeline inclination angle, D is a pipeline inner diameter, λ is a friction coefficient, and x is an axial distance along a pipeline.

The hyperbolic partial differential equations composed of the formula (1) and the formula (2) are solved using a method of characteristics and a finite difference method. By combining pipeline leakage boundary conditions and a leakage rate, an expression for a negative pressure wave at a leakage point may be obtained as:

$$\vert Δ p \vert = {ρα}_{s} \frac{{mv}_{0}}{2 - m} \qquad ( 3 )$$

Δp is a pressure change at the leakage point, αₛ is a pressure wave velocity, m is the leakage rate, and v₀ is a flow velocity before the pipeline leaks.

Neglecting an energy loss caused by a fluid movement in the pipeline network, by analyzing attenuation characteristics of the negative pressure wave during propagation, it can be concluded through a plurality of experimental analyses that an attenuation law of the negative pressure wave during transmission approximates exponential decay, with an expression being:

$${p}_{i} = ρ {α}_{s} \frac{{mv}_{0}}{2 - m} {e}^{- β x} \qquad ( 4 )$$

$${p}_{o} = ρ {α}_{s} \frac{{mv}_{0}}{2 - m} {e}^{- β ( l - x )} \qquad ( 5 )$$

pᵢ and pₒ are negative pressure wave pressure values at an inlet and an outlet of the pipeline network, respectively, β is a negative pressure wave attenuation factor, and l is a pipeline length.

Step 3: Construct a deep generative adversarial model based on a long short-term memory (LSTM) network

The deep generative adversarial network (GAN) constructed based on the LSTM network includes one generator G and one discriminator D. An objective of the generator is to generate a data sequence similar to a real data sequence, and a formula may be expressed as:

$${h}_{t}^{g} = LSTM ( {z}_{t} , {h}_{t - 1}^{g} ) \qquad ( 6 )$$

$${x}^{f} = tanh ( {W}^{g} {h}_{t}^{g} + {b}^{g} ) \qquad ( 7 )$$

$${h}_{t}^{g}$$

is a hidden state of a generator LSTM unit at time t, zₜ is a noise input,

$${h}_{t - 1}^{g}$$

is a hidden state of the generator LSTM unit at time t−1, W^{g} and b^{g} are a weight and a bias of the generator respectively, and x^{f} is generated fault data.

Further, an objective of the discriminator is to correctly classify real data and the generated data. When input data is the real data, a discriminator formula may be expressed as:

$${h}_{t}^{′} = LSTM ( {x}^{r} , {h}_{t - 1}^{′} ) \qquad ( 8 )$$

$${D}_{r} = sigmoid ( {W}^{d} {h}_{t}^{′} + {b}^{d} ) \qquad ( 9 )$$

h′ₜ is a hidden state of a discriminator LSTM unit at time t, x^{r} is real data, h′ₜ₋₁ is a hidden state of the discriminator LSTM unit at time t−1, and W^{d} and b^{d} are a weight and a bias of the discriminator respectively. When the input data is the generated data, the discriminator formula may be expressed as:

$${h}_{t}^{′} = LSTM ( {x}^{f} , {h}_{t - 1}^{′} ) \qquad ( 10 )$$

$${D}_{f} = sigmoid ( {W}^{d} {h}_{t}^{′} + {b}^{d} ) \qquad ( 11 )$$

Step 4: Construct a data-model dual-driven deep generative adversarial model using a series-parallel hybrid mechanism, namely, a hybrid generative adversarial model

The series-parallel hybrid mechanism firstly embeds an attenuation model into the generator, so as to ensure that the generated fault data conforms to the attenuation law of a negative pressure wave signal in a real operation scenario, and improve the physical rationality of the generated data. Accordingly, the negative pressure wave attenuation model needs to be embedded into a neural network as a physical constraint layer, and a key parameter, namely the leakage rate m, is used as a parameter for network updates. Then, the mechanism uses a prediction error between an inlet-outlet pressure difference of the generated fault data and that of the real data as a regularization term to ensure that the generated fault data conforms to characteristics of a real pipeline network, with a formula shown below:

L_{phy}=∥\hat{p}ᵢ−pᵢ∥²+∥\hat{p}ₒ−pₒ∥² (12)

\hat{p}ₒ and \hat{p}ᵢ are the inlet-outlet pressure differences for the generated fault data, respectively.

Based on a formula (11), it can be obtained that a generator loss of the hybrid generative adversarial model is:

$${L}_{G} = - \frac{1}{{n}^{r}} {\sum }_{i = 1}^{{n}^{r}} log ( D ( {x}_{i}^{f} ) ) + {L}_{phy} \qquad ( 13 )$$

and
a discriminator loss of the hybrid generative adversarial model is:

$${L}_{D} = - \frac{1}{{n}^{r}} {\sum }_{i = 1}^{{n}^{r}} [ log ( D ( {x}_{i}^{r} ) ) + log ( 1 - D ( {x}_{i}^{f} ) ) ] \qquad ( 14 )$$

Step 5: Update network parameters using an RMSProp optimizer

The generator and the discriminator are alternately trained using the RMSProp optimizer, firstly, the generator is fixed, and the discriminator loss L_{D} is minimized; and then, the discriminator is fixed, and the generator loss L_{G} is minimized.

Step 6: Generate fault data using the hybrid generative adversarial model to balance the training set

After the training of the hybrid generative adversarial model is completed, noise in step 3 is inputted into the generator to generate the fault data for expanding the diagnostic training set.

Step 7: Train a diagnosis model to implement pipeline network fault type identification

The pipeline fault diagnosis model is trained by using the oil and gas pipeline network data set obtained in step 6 to obtain a pipeline fault class.

In step 1, the oil and gas pipeline network monitoring system is used to collect the pipeline network negative pressure wave parameters, and construct a real data set. In step 2, the pipeline flow equations of the pipeline network are established by using the continuity equation and the motion equation, and the negative pressure wave attenuation model is constructed in combination with the method of characteristics and the finite difference method. In step 3, the established LSTM-based deep generative adversarial model is configured to process time sequence data. An implementation process of the series-parallel hybrid mechanism adopted in the hybrid generative adversarial model is as follows: (1) firstly, the negative pressure wave attenuation model is embedded into the neural network as the physical constraint layer, and the key parameter, namely the leakage rate m, is used as the parameter for network updates; and (2) then, the mechanism uses the prediction error between the inlet-outlet pressure difference of the generated fault data and that of the real data as the regularization term to ensure that the generated fault data conforms to the characteristics of the real pipeline network.

### EMBODIMENT

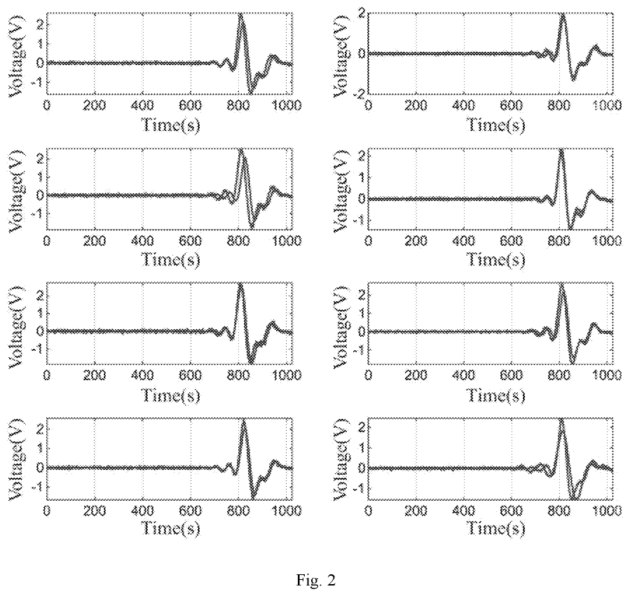

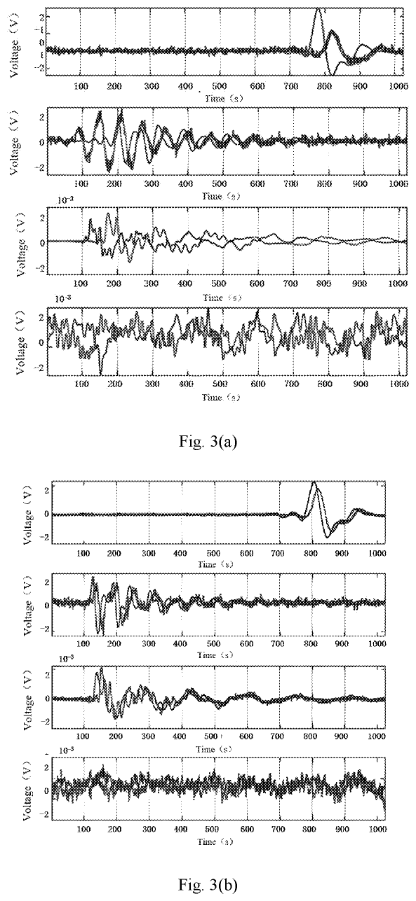

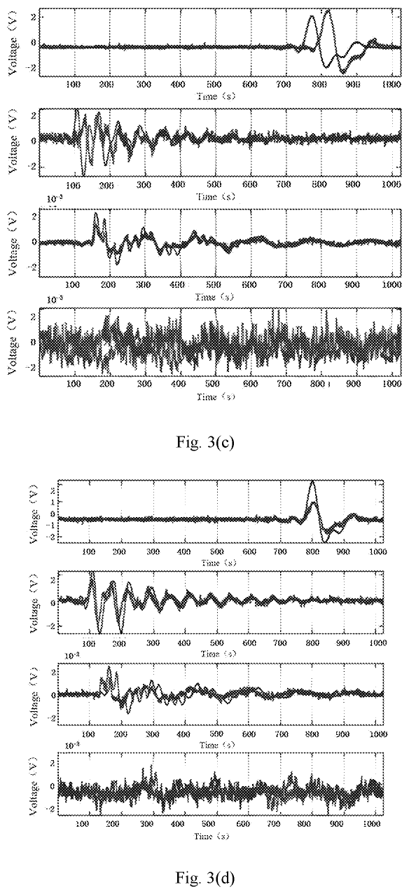

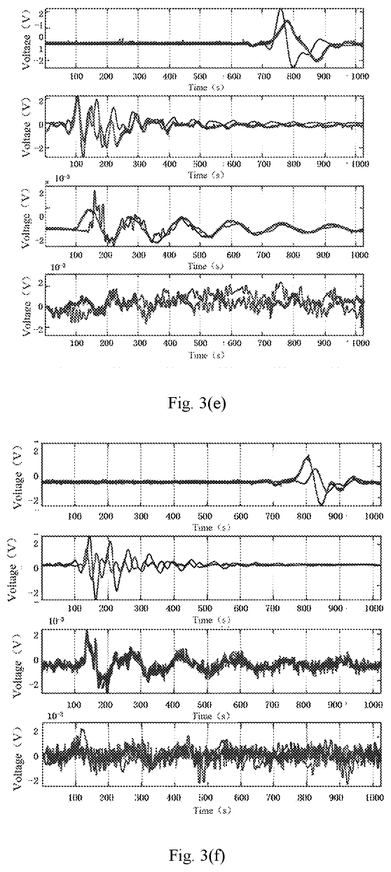

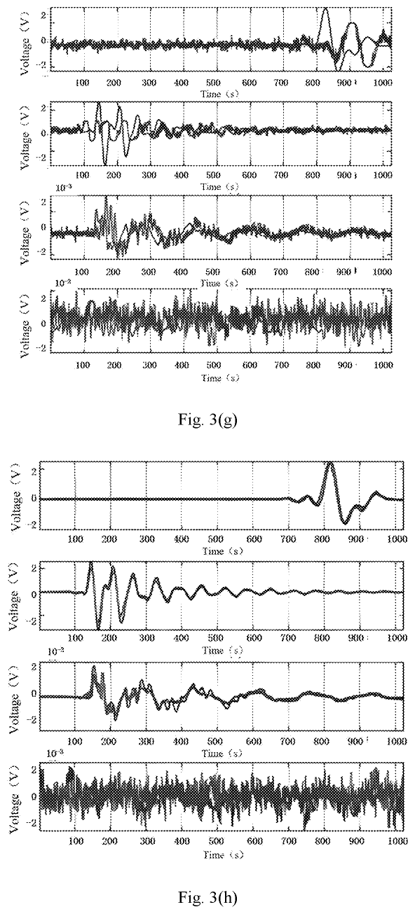

Based on the above-mentioned technical solution, the effectiveness of the method in the present disclosure is validated below through a case of fault diagnosis in an oil and gas pipeline network, as illustrated in FIG. 1, FIG. 2, and FIG. 3(a) to FIG. 3(h).

### 1. Experimental Setup

Training data used in the present disclosure is collected from a pressure sensor on a pipeline simulation platform (collected from a pressure sensor on a ZJ-CGGD platform, with a total pipeline length of 180 m, a pressure of 0.5 Mpa, a flow rate of 10 m\hat{ }3/h, and a sampling frequency of 1024 Hz). The total length of the pipeline is 180 m, and during an experiment, the pressure is set to 0.5 Mpa, the flow rate is 10 m³/h, and the sampling frequency of the signal is 1024 Hz. According to a valve opening and closing degree, the generated model data set includes four health states: large leakage, medium leakage, small leakage, and normal, with a total sample size of 2000 and a sample size of 500 for each health condition.

The hybrid generative adversarial model is composed of the generator and the discriminator, where the generator and discriminator are both composed of 3-layer LSTM networks. In a training process of the hybrid generative adversarial model, the total number of iterations is 5000; in each loop, the discriminator is trained 10 times, and the generator is trained once; a batch size is 128; the optimizer used for training is RMSProp, with a learning rate of 1e-4. The algorithms mentioned in the present disclosure are all built by a PyTorch framework and trained on an NVIDIA GEFORCE RTX 3090 GPU.

FIG. 2 is a visualization diagram of generated data and real data according to an embodiment of the present disclosure: the generated data and the real data obtained through the above-mentioned steps are drawn into the same coordinate system in the form of a line chart, where the generated data is dark, and the real data is light.

### 2. Comparative Algorithms

In order to comprehensively evaluate the performance of the hybrid generative adversarial model, the present disclosure selects seven generative models for comparison. Details are as follows:
VAE: variational autoencoder;
GAN-minmax: GAN original form;
LSGAN: a GAN variant using a mean squared error as a loss function;
InfoGAN: a GAN variant that controls a generation mode by inputting latent representations;
SeqGAN: a GAN variant utilizing reinforcement learning to generate series data;
TTS-GAN: a GAN variant constructing the generator and discriminator using a transformer; and
MAD-GAN: a GAN variant constructing the generator and discriminator using LSTM-RNN.

### 3. Visual Performance Evaluation

Through comparison with the performance of the seven generative models, the performance of the hybrid generative adversarial model may be proved, and experimental results are shown in FIG. 3. From FIG. 3 (a), it can be seen that data generated by the VAE and actual data have significant differences. Moreover, as shown in FIG. 3 (e) to FIG. 3 (g), data generated by SeqGAN, TTS-GAN, and MAD-GAN is more realistic than that in the above-mentioned methods, but contains many interferences, which may lead to low classification accuracy. Compared with the above-mentioned results, the data generated by the hybrid generative adversarial model maintains a high degree of consistency with the real pipeline data. In addition, it should be noted that a red curve in FIG. 3 (h) is smoother than curves in other images, which indicates that the hybrid generative adversarial model in the present disclosure is more stable than the other seven generative models.

### 4. Quantitative Evaluation Using Metrics

In this section, a maximum mean discrepancy metric is used to quantify a difference between a generated data distribution and a real distribution, so as to evaluate a similarity between the two distributions. The experimental results are shown in Table 1, and it can be clearly seen that the performance of the hybrid generative adversarial model is better than that of other generative models. Specifically, the maximum mean discrepancy metric value of the hybrid generative adversarial model in large leakage, medium leakage, and small leakage states is the smallest among all algorithms, which indicates that the hybrid generative adversarial model has an advantage in restoring obvious features of the real-world distribution. In contrast, other models can only generate data that partially reflects the characteristics of the pipeline data because the other models are largely affected by training instability. Therefore, developing the hybrid generative adversarial model is of practical significance because the pipeline data distribution the hybrid generative adversarial model generates has similar statistical properties to the real-world data distribution.

TABLE 1
Quantitative evaluation results of metrics

| | Large | Medium | Small | Normal |
|---|---|---|---|---|
| Algorithm | leakage | leakage | leakage | state |
| VAE | 2.81 | 2.77 | 2.31 | 3.80 |
| GAN-minmax | 2.62 | 5.15 | 3.94 | 2.16 |
| LSGAN | 1.90 | 2.95 | 2.77 | 1.73 |
| InfoGAN | 1.85 | 1.76 | 3.43 | 3.63 |
| SeqGAN | 1.96 | 1.96 | 3.43 | 3.63 |
| TTS-GAN | 0.73 | 3.43 | 1.93 | 1.64 |
| MAD-GANS | 1.64 | 4.22 | 1.60 | 1.64 |
| MGSAN | 0.15 | 0.15 | 1.73 | 0.63 |

Embodiment: Taking fault diagnosis of an oil pipeline as a case, the effectiveness of the fault diagnosis through the method in the present disclosure is validated.

A real data set is acquired from an oil pipeline fault simulation platform. This data set includes four categories: normal, large leakage, medium leakage, and small leakage. Fault data is acquired under a state with a pressure of 0.5 MPa, and a data acquisition frequency is 1024 Hz. An original data set contains 3000 normal-state data points, with 200 data points each for large leakage, medium leakage, and small leakage. Data of three fault types generated by the hybrid generative adversarial model is supplemented into the original data set, that is, after the supplementation operation, the original data set contains 3000 pipeline network data points each for four types. In order to reduce the influence of random factors and validate the reliability of the present disclosure, all diagnostic experiments are repeated ten times, and a mean accuracy over ten times of diagnoses is calculated. Experimental results are shown in Table 2 and Table 3. From the experimental results, it can be found that: 1) the sufficient and balanced pipeline network data set significantly improves the performance of the diagnosis model; and 2) compared with the other seven generative models, the training data set constructed by the hybrid generative adversarial model has the highest accuracy.

TABLE 2
Fault diagnosis accuracy (1)

| | VAE | | GAN-minmax | | LSGAN | | InfoGAN | |
|---|---|---|---|---|---|---|---|---|
| | Train- | | Train- | | Train- | | Train- | |
| Times | ing | Test | ing | Test | ing | Test | ing | Test |
| 1 | 0.996 | 0.818 | 0.989 | 0.898 | 0.991 | 0.869 | 0.905 | 0.859 |
| 2 | 0.908 | 0.738 | 0.966 | 0.875 | 0.961 | 0.881 | 0.831 | 0.798 |
| 3 | 0.927 | 0.875 | 0.971 | 0.879 | 0.988 | 0.906 | 0.862 | 0.833 |
| 4 | 0.967 | 0.758 | 0.977 | 0.863 | 0.997 | 0.894 | 0.807 | 0.782 |
| 5 | 0.869 | 0.768 | 0.973 | 0.883 | 0.970 | 0.838 | 0.821 | 0.803 |
| 6 | 0.906 | 0.856 | 0.952 | 0.999 | 0.959 | 0.861 | 0.852 | 0.815 |
| 7 | 0.914 | 0.838 | 0.979 | 0.904 | 0.958 | 0.868 | 0.838 | 0.799 |
| 8 | 0.909 | 0.844 | 0.980 | 0.892 | 0.986 | 0.925 | 0.919 | 0.872 |
| 9 | 0.934 | 0.735 | 0.989 | 0.869 | 0.995 | 0.913 | 0.921 | 0.857 |
| 10 | 0.834 | 0.743 | 0.980 | 0.863 | 0.978 | 0.888 | 0.928 | 0.834 |
| Mean | 0.918 | 0.797 | 0.976 | 0.881 | 0.978 | 0.884 | 0.868 | 0.825 |

TABLE 3
Fault diagnosis accuracy (2)

| | | | | | | | Hybrid | |
|---|---|---|---|---|---|---|---|---|
| | | | | | | | generative | |
| | | | | | | | adversarial | |
| | SeqGAN | | TTS-GAN | | MAD-GAN | | model | |
| | Train- | | Train- | | Train- | | Train- | |
| Times | ing | Test | ing | Test | ing | Test | ing | Test |
| 1 | 0.931 | 0.924 | 0.921 | 0.915 | 0.954 | 0.913 | 0.997 | 0.963 |
| 2 | 0.935 | 0.944 | 0.946 | 0.943 | 0.929 | 0.882 | 0.987 | 0.975 |
| 3 | 0.934 | 0.944 | 0.907 | 0.912 | 0.960 | 0.931 | 0.992 | 0.967 |
| 4 | 0.875 | 0.874 | 0.931 | 0.919 | 0.921 | 0.905 | 0.990 | 0.979 |
| 5 | 0.948 | 0.954 | 0.933 | 0.928 | 0.953 | 0.935 | 0.992 | 0.971 |
| 6 | 0.896 | 0.894 | 0.938 | 0.937 | 0.954 | 0.933 | 0.988 | 0.983 |
| 7 | 0.935 | 0.932 | 0.917 | 0.922 | 0.890 | 0.863 | 0.996 | 0.992 |
| 8 | 0.930 | 0.945 | 0.910 | 0.907 | 0.921 | 0.889 | 0.994 | 0.988 |
| 9 | 0.937 | 0.940 | 0.938 | 0.939 | 0.926 | 0.909 | 0.984 | 0.979 |
| 10 | 0.925 | 0.939 | 0.930 | 0.927 | 0.949 | 0.930 | 0.993 | 0.989 |
| Mean | 0.924 | 0.929 | 0.927 | 0.925 | 0.935 | 0.909 | 0.991 | 0.979 |

In summary, according to the method provided in the present disclosure, the generated data not only conforms to physical characteristics of real-world pipeline network operations, but also surpasses existing comparative methods in terms of visualization performance and statistical properties, thereby effectively reducing the risk of missed alarm and false alarm, and improving the accuracy of pipeline fault diagnosis. Through simulation experiments and practical applications for the method in the present disclosure, technical effects and practicability claimed by the present disclosure are validated.

The algorithm (method) proposed by the present disclosure serves as an underlying technical core of the present disclosure, and various products can be derived based on the algorithm.

Based on the algorithm (method) proposed by the present disclosure, a data-model dual-driven fault diagnosis system for an oil and gas pipeline network in a class imbalance data scenario is developed using programming languages. The system has a program device corresponding to the steps of the above-mentioned technical solution, and the steps of the above-mentioned data-model dual-driven fault diagnosis method for an oil and gas pipeline network in a class imbalance data scenario are performed when running.

A computer program of the developed system (software) is stored on a computer-readable storage medium. The computer program is configured to implement the steps of the above-mentioned data-model dual-driven fault diagnosis method for an oil and gas pipeline network in a class imbalance data scenario when called by a processor. That is, the present disclosure is materialized on a carrier to become a computer program product.

The present disclosure further provides an oil and gas pipeline network fault diagnosis device. The oil and gas pipeline network fault diagnosis device includes at least one processor, and a memory which is in communication connection with the at least one processor, where the memory stores instructions executable by the at least one processor, and the instructions, when executed by the at least one processor, cause the at least one processor to perform the above-mentioned data-model dual-driven fault diagnosis method for an oil and gas pipeline network in a class imbalance data scenario. The oil and gas pipeline network fault diagnosis device is used as a terminal intelligent product for the application of the present disclosure, and applied to oil and gas pipeline network fault diagnosis.

The various implementations of the systems and technologies described herein may be implemented in a digital electronic circuit system, an integrated circuit system, a dedicated application-specific integrated circuit (ASIC), computer hardware, firmware, software, and/or combinations thereof. These various implementations may include implementing in one or more computer programs. The one or more computer programs may be executed and/or interpreted on a programmable system including at least one programmable processor. The programmable processor may be a dedicated or general-purpose programmable processor capable of receiving data and instructions from a storage system, at least one input apparatus, and at least one output apparatus, and transmitting the data and the instructions to the storage system, the at least one input apparatus, and the at least one output apparatus.

Computing programs (also referred to as programs, software, software applications, or code) in the present disclosure include machine instructions of the programmable processor, and these computing programs may be implemented using high-level procedural and/or object-oriented programming languages, and/or assembly/machine languages. As used herein, the terms “machine-readable medium” and “computer-readable medium” refer to any computer program product, device, and/or apparatus (e.g., a magnetic disk, an optical disk, a memory, and a programmable logic device (PLD)) for providing the machine instructions and/or the data to the programmable processor, including the machine-readable medium that receives machine instructions as machine-readable signals. The term “machine-readable signal” refers to any signal configured to provide the machine instructions and/or the data to the programmable processor.

It should be understood that the various forms of process flows illustrated above may be used to allow for the steps to be reordered, added, or deleted. For example, the steps recorded in this application may be performed in parallel, or performed in sequence, or performed in different sequences, which all fall within the scope of protection of the present disclosure as long as results expected by the technical solutions disclosed in this application can be implemented.

What is claimed is:

1. A data-model dual-driven fault diagnosis method for an oil and gas pipeline network in a class imbalance data scenario, wherein an implementation process of the fault diagnosis method for the oil and gas pipeline network is as follows:
step 1: collecting key pipeline network parameters and constructing a training data set, wherein:
an oil and gas pipeline network monitoring system is used to acquire pipeline network negative pressure wave parameters and construct a training set
$${D}_{r} = {\{ {x}_{i}^{r} , {y}_{i}^{r} \}}_{i = 1}^{{n}^{r}} ,$$
wherein
$${x}_{i}^{r}$$
is i-th real pipeline data composed of N sampling points;
$${y}_{i}^{r}$$
is an i-th data label; and n^{r} is the number of data;
step 2: establishing a negative pressure wave attenuation physical model, wherein:
change laws of pipeline network negative pressure wave characteristics under the influence of environmental and external factors are analyzed, and pipeline flow equations of the pipeline network are established based on the principles of mass conservation and momentum conservation, namely a set of hyperbolic partial differential equations composed of a continuity equation and a motion equation for fluid:
$$\frac{\partial ρ}{\partial t} + ∇ \cdot ( ρ v ) = 0 \qquad ( 1 )$$
$$\frac{\partial v}{\partial t} + v \frac{\partial v}{\partial x} + \frac{1}{ρ} \frac{\partial ρ}{\partial x} + g sin θ + \frac{λ}{2 D} v \vert v \vert = 0 \qquad ( 2 )$$
wherein ρ is a fluid density, v is a flow velocity, t is time, p is a pressure, g is a gravitational acceleration, θ is a pipeline inclination angle, D is a pipeline inner diameter, λ is a friction coefficient, x is an axial distance along a pipeline, and ∇ represents a gradient;
the hyperbolic partial differential equations composed of the formula (1) and the formula (2) are solved using a method of characteristics and a finite difference method, and by combining pipeline leakage boundary conditions and a leakage rate, an expression for a negative pressure wave at a leakage point is obtained as:
$$\vert Δ p \vert = {ρα}_{s} \frac{{mv}_{0}}{2 - m} \qquad ( 3 )$$
wherein Δp is a pressure change at the leakage point, αₛ is a pressure wave velocity, m is the leakage rate, and v₀ is a flow velocity before the pipeline leaks; and
neglecting an energy loss caused by a fluid movement in the pipeline network, and by analyzing attenuation characteristics of the negative pressure wave during propagation, it is concluded that an attenuation law of the negative pressure wave during transmission approximates exponential decay, with an expression being:
$${p}_{i} = ρ {α}_{s} \frac{{mv}_{0}}{2 - m} {e}^{- β x} \qquad ( 4 )$$
$${p}_{o} = ρ {α}_{s} \frac{{mv}_{0}}{2 - m} {e}^{- β ( l - x )} \qquad ( 5 )$$
wherein pᵢ and pₒ are negative pressure wave pressure values at an inlet and an outlet of the pipeline network, respectively, β is a negative pressure wave attenuation factor, and l is a pipeline length;
step 3: constructing a deep generative adversarial model based on a long short-term memory network, wherein:
the deep generative adversarial network constructed based on the long short-term memory network comprises one generator G and one discriminator D, an objective of the generator is to generate a data sequence similar to a real data sequence, and a formula is capable of being expressed as:
$${h}_{t}^{g} = LSTM ( {z}_{t} , {h}_{t - 1}^{g} ) \qquad ( 6 )$$
$${x}^{f} = tanh ( {W}^{g} {h}_{t}^{g} + {b}^{g} ) \qquad ( 7 )$$
wherein
$${h}_{t}^{g}$$
is a hidden state of a generator LSTM unit at time t, zₜ is a noise input,
$${h}_{t - 1}^{g}$$
is a hidden state of the generator LSTM unit at time t−1, W^{g} and b^{g} are a weight and a bias of the generator respectively, and x^{f} is generated fault data; and
the discriminator is configured to correctly classify real data and generated data, and when input data is the real data, a discriminator formula is expressed as:
$${h}_{t}^{′} = LSTM ( {x}^{r} , {h}_{t - 1}^{′} ) \qquad ( 8 )$$
$${D}_{r} = sigmoid ( {W}^{d} {h}_{t}^{′} + {b}^{d} ) \qquad ( 9 )$$
wherein h′ₜ is a hidden state of a discriminator LSTM unit at time t, x^{r} is the real data, hₜ₋₁ is a hidden state of the discriminator LSTM unit at time t−1, and W^{d} and b^{d} are a weight and a bias of the discriminator respectively; and when the input data is the generated data, the discriminator formula is capable of being expressed as:
$${h}_{t}^{′} = LSTM ( {x}^{f} , {h}_{t - 1}^{′} ) \qquad ( 10 )$$
$${D}_{f} = sigmoid ( {W}^{d} {h}_{t}^{′} + {b}^{d} ) \qquad ( 11 )$$
step 4: constructing a data-model dual-driven deep generative adversarial model using a series-parallel hybrid mechanism, namely, a hybrid generative adversarial model, wherein:
the series-parallel hybrid mechanism is as follows: an attenuation model is firstly embedded into the generator, so as to ensure that the generated fault data conforms to an attenuation law of a negative pressure wave signal in a real operation scenario, and improve the physical rationality of the generated data; the negative pressure wave attenuation model is embedded into a neural network as a physical constraint layer, and a key parameter, namely the leakage rate m, is used as a parameter for network updates; and then, the mechanism uses a prediction error between an inlet-outlet pressure difference of the generated fault data and that of the real data as a regularization term to ensure that the generated fault data conforms to characteristics of a real pipeline network, with a formula shown below:
L_{phy}=∥\hat{p}ᵢ−pᵢ∥²+∥\hat{p}ₒ−pₒ∥² (12)
wherein \hat{p}ₒ and \hat{p}ᵢ are the inlet-outlet pressure differences for the generated fault data, respectively;
based on a formula (11) a generator loss of the hybrid generative adversarial model is:
$${L}_{G} = - \frac{1}{{n}^{r}} {\sum }_{i = 1}^{{n}^{r}} log ( D ( {x}_{i}^{f} ) ) + {L}_{phy} ; \qquad ( 13 )$$
and
a discriminator loss of the hybrid generative adversarial model is:
$${L}_{D} = - \frac{1}{{n}^{r}} {\sum }_{i = 1}^{{n}^{r}} [ log ( D ( {x}_{i}^{r} ) ) + log ( 1 - D ( {x}_{i}^{f} ) ) ] \qquad ( 14 )$$
step 5: updating network parameters using an RMSProp optimizer, wherein:
the generator and the discriminator are alternately trained using the RMSProp optimizer, firstly, the generator is fixed, and the discriminator loss L_{D} is minimized; and then, the discriminator is fixed, and a generator loss L_{G} is minimized;
step 6: generating fault data using the hybrid generative adversarial model to balance the training set, wherein:
after the training of the hybrid generative adversarial model is completed, noise in step 3 is inputted into the generator to generate the fault data for expanding the diagnostic training set; and
step 7: training a diagnosis model to implement pipeline network fault type identification, wherein:
the pipeline fault diagnosis model is trained by using the oil and gas pipeline network data set obtained in step 6 to obtain a pipeline fault class.

2. The data-model dual-driven fault diagnosis method for the oil and gas pipeline network in the class imbalance data scenario according to claim 1, wherein in step 1, the oil and gas pipeline network monitoring system is used to collect the pipeline network negative pressure wave parameters, and construct a real data set.

3. The data-model dual-driven fault diagnosis method for the oil and gas pipeline network in the class imbalance data scenario according to claim 1, wherein in step 2, the pipeline flow equations of the pipeline network are established by using the continuity equation and the motion equation, and the negative pressure wave attenuation model is constructed in combination with the method of characteristics and the finite difference method.

4. The data-model dual-driven fault diagnosis method for the oil and gas pipeline network in the class imbalance data scenario according to claim 1, wherein in step 3, the established LSTM-based deep generative adversarial model is configured to process time sequence data.

5. The data-model dual-driven fault diagnosis method for the oil and gas pipeline network in the class imbalance data scenario according to claim 1, wherein an implementation process of the series-parallel hybrid mechanism adopted in the hybrid generative adversarial model is as follows:
(1) the negative pressure wave attenuation model being firstly embedded into the neural network as the physical constraint layer, and the key parameter, namely the leakage rate m, being used as the parameter for network updates; and
(2) then, the mechanism using the prediction error between the inlet-outlet pressure difference of the generated fault data and that of the real data as the regularization term to ensure that the generated fault data conforms to the characteristics of the real pipeline network.

6. The data-model dual-driven fault diagnosis method for the oil and gas pipeline network in the class imbalance data scenario according to claim 1, wherein W^{d} and b^{d} in the discriminator formula Dᵣ are obtained through adaptive optimization according to a set loss function.
